(19) United States
(12) Patent Application Publication
(10) Pub. No.: US 2009/0033198 A1
(43) Pub. Date: Feb. 5, 2009

(54) Electric lamp with an outer bulb and an integral lamp and a method for its production

(75) Inventors: Bernd Naujoks, Neve Zamky (SK); Roland Stark, Wellheim (DE)

Correspondence Address: OSRAM SYLVANIA INC, 100 ENDICOTT STREET, DANVERS, MA, 01923, US

(73) Assignee: OSRAM GESELLSCHAFT MIT BESCHRANKTER HAFTUNG, MUNCHEN (DE)

(21) Appl. No.: 12/216,448

(22) Filed: Jul. 3, 2008

(30) Foreign Application Priority Data
Jul. 30, 2007 (DE) 10 2007 035 595.7

(51) Int. Cl. H01J 5/48; H01J 9/00

(52) U.S. Cl. 313/318.01; 445/23

(57) ABSTRACT

The invention relates to an electric lamp (1) with a base at one end and with an outer bulb (3), mounted in a base (2), and at least one integral lamp (4), preferably a high-volt halogen lamp, which is arranged within the outer bulb (3), and at least two power supply wires (9, 9a, 9b) from the base (2) to the integral lamp (4). The invention likewise relates to a method for producing such a lamp. The at least two power supply wires (9, 9a, 9b) are surrounded by a preferably cylindrical bulb (6) made from nonconductive material, and the cylindrical bulb (6) is connected, preferably fused, to the outer bulb (3).

### TECHNICAL FIELD

The invention relates to an electric lamp with a base at one end and with an outer bulb, mounted in a base, and at least one integral lamp, preferably a high-volt halogen lamp, which is arranged within the outer bulb, and at least two power supply wires from the base to the integral lamp. The invention furthermore relates to a method for producing an electric lamp with a base at one end and with an outer bulb, mounted in a base, and at least one integral lamp, preferably a high-volt halogen lamp, which is arranged within the outer bulb, and at least two power supply wires leading from the base to the integral lamp.

### PRIOR ART

As a result of their long life and pleasant light quality, halogen incandescent lamps are increasingly preferred to conventional incandescent lamps. In order to make it possible to replace existing incandescent lamps with halogen incandescent lamps as simply as possible and at the same time to maintain the visual appearance of a conventional incandescent lamp for aesthetic or functional reasons, lamps are often used in which the outer contour and therefore in particular the outer bulb and the base correspond to a conventional incandescent lamp, while a halogen incandescent lamp is arranged as an integral lamp within the outer bulb. Such lamps are produced and marketed, for example, by OSRAM GmbH under the designation “HALOLUX® CLASSIC”.

In order to bring the outward appearance and the luminous properties of such a lamp close to those of a conventional incandescent lamp, the incandescent wire of the integral lamp needs to be arranged approximately at the same point as the incandescent wire of a comparable conventional incandescent lamp. For this purpose, the substantially more compact halogen lamp needs to be positioned in the outer bulb by means of a holder.

It is known from EP 0 498 256 to fix the integral lamp directly to two power supply wires and therefore to use them as the holder. However, this is only possible with relatively short power supply wires since otherwise the lamp will be extremely sensitive to vibrations and, in the event of breakage of the outer bulb, the power supply wires conducting mains voltage will be exposed.

A technology used in the abovementioned “HALOLUX® CLASSIC” lamps for positioning the integral lamp consists in providing a vitreous plate-like stand, which is fused into the outer bulb. The plate-like stand bears a frame manufactured from metal by means of which the halogen integral lamp is in turn held. Furthermore, power supply wires are fused into the plate-like stand, and the power supply wires of the integral lamp are welded to said power supply wires. This design requires, in order to pass the power supply wires through the vitreous plate-like stand, a three-part design and is generally very complex as a result of the combination of metallic and vitreous components.

DE 10 2005 051 076 has disclosed a holder for the integral lamp, which holder comprises a metallic mounting clip, into which the integral lamp is inserted. The mounting clip is fitted on the vitreous stand of the outer bulb, which is very involved, however, since the vitreous stand represents a very complex component which comprises, for example, an exhaust tube and fused-in power supply wires. When using a metallic mounting clip, there is in addition the risk of damage to the outer bulb when the lamp is fitted or operated and it is necessary to ensure that no live parts come into contact with the clip. Furthermore, the metallic holder is visually very obvious and considerably disrupts the transparent outward appearance known from a conventional incandescent lamp.

### DESCRIPTION OF THE INVENTION

With respect to the lamp, the invention is therefore based on the object of providing an electric lamp with a base at one end and with an outer bulb, mounted in a base, and at least one integral lamp, preferably a high-volt halogen lamp, which is arranged within the outer bulb, and at least two power supply wires from the base to the integral lamp, which lamp can be produced in a robust and simple manner and in the case of which the power supply wires are protected reliably from touching contact with the risk of electric shock in the event of breakage of the outer bulb.

With respect to the method for producing a lamp, the invention is furthermore based on the object of providing a method for producing an electric lamp with a base at one end and with an outer bulb, mounted in a base, and at least one integral lamp, preferably a high-volt halogen lamp, which is arranged within the outer bulb, and at least two power supply wires from the base to the integral lamp, which method makes it possible to produce such a lamp in a simple manner.

With respect to the lamp, the object is achieved according to the invention by virtue of the fact that the at least two power supply wires are surrounded by a preferably cylindrical bulb made from nonconductive material, and the cylindrical bulb is connected, preferably fused, to the outer bulb.

As a result of the simple geometry, such a bulb can be produced with substantially less complexity than, for example, a plate-like stand and provides good protection against touching contact for the power supply wires. The connection to the outer bulb makes it possible to hold the preferably cylindrical bulb securely and to position it optimally. As a result, the preferably cylindrical bulb can also be used, for example, for holding and/or stabilizing the integral lamp.

By virtue of the fact that the cylindrical bulb is formed from a light-permeable material, preferably identical to the material used for the outer bulb, in particular glass, a good connection between the two bulbs can be produced with little complexity, for example by means of fuse-sealing, and shading of the light emerging from the integral lamp can be avoided. In particular, the preferably cylindrical bulb can approximately completely surround the integral lamp and therefore form an additional protection for it. Faults, such as damage to the power supply wires or the integral lamp, for example, can also still be easily identified once the lamp is complete. The visual impression of the lamp is additionally largely identical to that of a conventional incandescent lamp.

It is particularly advantageous if the integral lamp is at least partially surrounded by the preferably cylindrical bulb. As a result, particularly effective protection is achieved and the integral lamp can be supported or guided laterally on the bulb, as a result of which the power supply wires are at least partially relieved of these forces and can therefore have a less complex design.

It is advantageous if at least one holding apparatus for fixing the integral lamp is provided on the preferably cylindrical bulb. As a result, the cylindrical bulb can take on holding forces of the integral lamp. The power supply wires are therefore relieved of these forces and the design of the power supply wires and their holders can be configured to be simpler and more cost-effective.

It is likewise particularly advantageous if the holding apparatus has at least one spring element. Spring elements are particularly well suited for producing a force-fitting connection between components and in the process compensating for dimensional tolerances or irregularities.

It is likewise advantageous if the holding apparatus has at least one holding clip for the integral lamp, comprising at least two holding lugs, which are preferably arranged approximately planar-parallel. A holding clip makes it possible to fit the integral lamp in a simple manner. In particular in the case of the integral lamps which are typically used with a pinch-seal base, holding lugs which are arranged in planar-parallel fashion are particularly suitable.

It is furthermore expedient if at least one of the holding lugs comprises at least one spring element, in particular is in the form of a spring element. This makes it possible to hold the integral lamp in a simple manner with little production complexity involved for the holding lugs.

It is likewise advantageous if the holding apparatus can be connected in a force-fitting manner to the preferably cylindrical bulb by means of at least one spring element. As a result, a simple and secure connection is achieved which is insensitive to dimensional inaccuracies and irregularities.

Furthermore, it is advantageous if the spring element is operatively connected to at least one holding element, which is approximately in the form of a circular arc, the diameter of the circular arc approximately corresponding to the inner diameter or the outer diameter of the preferably cylindrical bulb. The element in the form of a circular arc is pressed against the cylindrical bulb by the spring element. The shaping of the element in the form of a circular arc produces a large bearing surface area against the cylindrical bulb and therefore a good connection between these two elements.

Advantageously, the holding element, which is approximately in the form of a circular arc, and the holding lugs of the holding clip are arranged axially spaced apart from one another. In this arrangement, the integral lamp can be arranged above the cylindrical bulb, and the cylindrical bulb can be configured so as to be shorter.

It is likewise expedient if the direction of force of the spring element of the holding element, which is approximately in the form of a circular arc, and of the holding lugs of the holding clip are arranged approximately orthogonally with respect to one another. This arrangement allows for a simple fitting since the force effect of the holding apparatus on the integral lamp and the force effect of the holding apparatus on the cylindrical bulb are arranged orthogonally with respect to one another and therefore the holding apparatuses do not influence one another.

In a further configuration of the invention, the direction of force of the spring element of the holding element, which is approximately in the form of a circular arc, and the holding lugs are arranged approximately parallel to one another. This arrangement allows for a space-saving and simple design, and a common spring element can be used for the holding lug and the holding element in the form of a circular arc.

It is furthermore advantageous if the holding apparatus has a substantially disk-shaped element with a cutout for accommodating the integral lamp, the disk-shaped element approximately having the cross-sectional area of the preferably cylindrical bulb. Such a disk can be held easily on or in the cylindrical bulb and takes up little installation space.

Expediently, the cutout for accommodating the integral lamp has approximately the contour of the cross-sectional area of the base of the integral lamp. This makes it possible to hold the integral lamp in the cutout without any or with only few additional auxiliary means.

It is likewise expedient if the disk-shaped element is in the form of a stamped part made from a metallic material. This makes it possible to manufacture the holding apparatus in a simple and cost-effective manner.

It is particularly advantageous if spring lugs for fixing the disk-shaped element are provided in the preferably cylindrical bulb and/or the integral lamp in the disk-shaped element. Spring lugs are, in particular in the case of metallic stamped parts, simple to manufacture and allow for simple fitting and secure holding.

In a further advantageous embodiment of the invention, the power supply wires are configured as a holding apparatus for the integral lamp. As a result, it is possible to dispense with an independent holding apparatus.

It is advantageous if at least one wire, which is coiled around the bulb of the integral lamp preferably in the form of a spiral and/or in the form of a ring, is arranged between the bulb of the integral lamp and the cylindrical bulb. The wire prevents direct contact between the integral lamp and the bulb, which is particularly advantageous in the case of a glass bulb since contact from glass to glass is therefore avoided and damage to the bulb or the integral lamp is prevented.

It is furthermore expedient if the coiled wire is connected, in particular welded, to a power supply wire, which leads from the base to the integral lamp. This makes simple holding for the coiled wire possible.

Advantageously, the coiled wire section and at least one power supply wire, which leads from the base to the integral lamp, are designed to be integral. As a result, a particularly simple design is achieved which reduces production complexity and avoids weakening by means of connecting points and/or welded joints.

It is likewise advantageous if at least one power supply wire, which leads from the base to the integral lamp, is connected to at least one power supply line of the integral lamp by a welded joint. As a result, a connection is produced using simple means which can safely and reliably transfer both mechanical forces and electrical current.

It is furthermore expedient if at least one power supply wire, which leads from the base to the integral lamp, is led, in the region of the base, in the form of a U around the cylindrical bulb. As a result, it is possible to make contact between the power supply wire and the lateral base region in a simple manner, at the same time secure holding of the power supply wire being made possible.

Advantageously, the power supply wires are formed from a nickel/copper alloy. Such alloys provide both good conductivity and good mechanical properties and high corrosion resistance.

With respect to the method, the object is achieved according to the invention by virtue of the fact that the method comprises the following steps:
a) the integral lamp is connected, preferably welded, to the power supply wires,
b) the power supply wires are inserted into a preferably cylindrical bulb made from a nonconductive material, with the result that the at least two power supply wires are largely surrounded by the preferably cylindrical bulb,
c) the outer bulb is connected, preferably fused, to the preferably cylindrical bulb,
d) one of the two power supply wires is bent back laterally in such a way that contact with a base can be produced,
e) the base is fitted onto the outer bulb and is preferably connected using cement applied to the base,
f) the power supply wires are cut to length and are connected to the base preferably by means of soldering.

This method allows for simple and efficient manufacture of a lamp according to the invention.

In an advantageous development of the invention, between steps a) and b), at least one of the power supply wires is coiled in the form of a ring and/or spiral around the bulb of the integral lamp. As a result, simple fitting and optimal matching of the winding to the bulb of the integral lamp is realized.

By virtue of the fact that at least one of the power supply wires is coiled in the form of a ring and/or spiral prior to being connected to the integral lamp, the coil or the ring can be used during fitting as a guide for the bulb of the integral lamp and the coil-formation process during production can be dispensed with.

In a further advantageous configuration of the invention, the integral lamp is introduced into a holding apparatus before or after step a). Introduction of the integral lamp into the holding apparatus before implementing further steps makes it possible to hold and handle it during the further steps using the holding apparatus.

### BRIEF DESCRIPTION OF THE DRAWING

The invention will be explained with reference to four exemplary embodiments. Identical or functionally identical components are identified by the same reference numerals. In the figures:

FIG. 1 shows a first exemplary embodiment of a lamp according to the invention in a perspective view,

FIG. 2 shows a lamp according to the invention in accordance with the first exemplary embodiment in a side view,

FIG. 3 shows a detail illustration of the integral lamp in accordance with the first exemplary embodiment in a side view,

FIG. 4 shows a second exemplary embodiment of a lamp according to the invention in a side view,

FIG. 5 shows a detail view of a lamp according to the invention in accordance with the second exemplary embodiment in a horizontal sectional illustration,

FIG. 6 shows a detail view of a lamp according to the invention in accordance with the second exemplary embodiment in a sectional detail view,

FIG. 7 shows a third exemplary embodiment of a lamp according to the invention in a side view,

FIG. 8 shows a lamp according to the invention in accordance with the third exemplary embodiment in a detail view,

FIG. 9 shows a fourth exemplary embodiment of a lamp according to the invention in a side view,

FIG. 10 shows a lamp according to the invention in accordance with the fourth exemplary embodiment in a lateral detail illustration,

FIG. 11 shows a fifth exemplary embodiment of a lamp according to the invention in a sectional detail view, and

FIG. 12 shows a lamp according to the invention in accordance with the fifth exemplary embodiment in a further lateral detail illustration.

### PREFERRED EMBODIMENT OF THE INVENTION

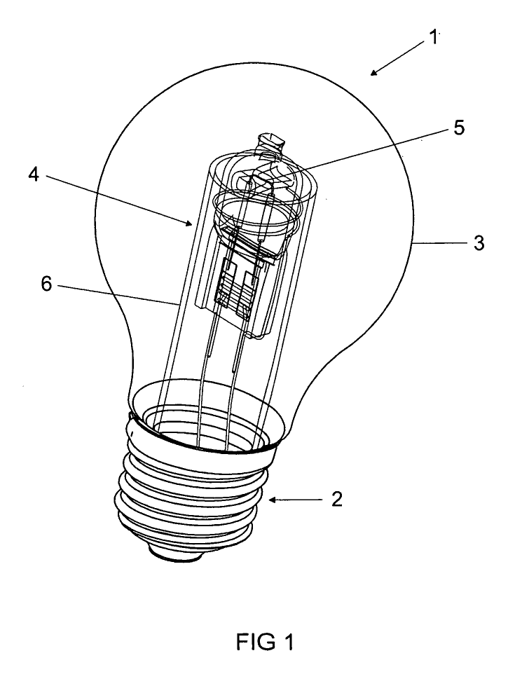

FIG. 1 shows a lamp 1 according to the invention in a perspective illustration. An outer bulb 3 of the type A55 is held in a base 2 of the conventional type E27. An integral lamp 4 is arranged within the outer bulb 3 in such a way that an incandescent wire 5 of the integral lamp 4 is located approximately at the point within the outer bulb 3 at which the incandescent wire is likewise arranged in a conventional incandescent lamp. The integral lamp 4 is configured as a so-called high-volt halogen lamp using pinching technology and is known as such from the prior art. Furthermore, a cylindrical bulb 6 is provided which surrounds the integral lamp 4 up to approximately the entire length and extends as far as the base 2.

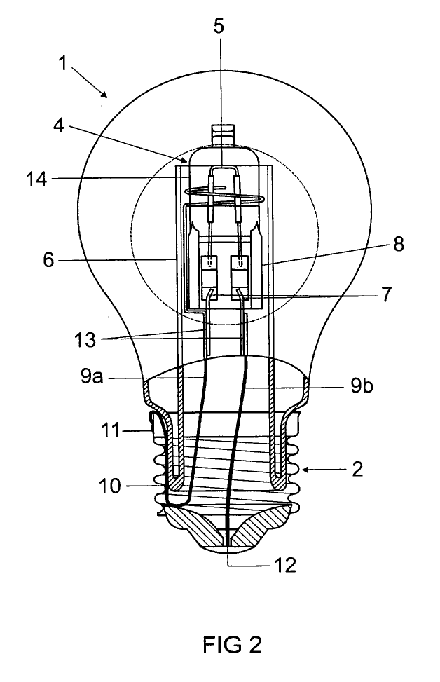

Details of the design can be seen particularly clearly in FIG. 2. The incandescent wire 5 of the integral lamp 4 is connected to power supply lines 7, which protrude out of a base 8 of the integral lamp 4.

The power supply lines 7 of the integral lamp 4 are fixed on power supply wires 9a, 9b, which are held in the base 2 of the lamp 1. The integral lamp 4 is therefore both held and supplied with current by the power supply wires 9a, 9b.

The cylindrical bulb 6 is fused to the outer bulb 3 in the region of the lamp stand 10. As a result, holding apparatuses for the cylindrical bulb 6 are not required. The two power supply wires 9a, 9b are passed out of the cylindrical bulb 6, and the first power supply wire 9a is bent in the form of a U and soldered to a base sleeve 11 of the base 2, while the second power supply wire 9b is connected to a bottom contact 12 likewise by means of soldering.

The two power supply wires 9a, 9b are manufactured from a copper/nickel alloy, as is marketed, for example, under the trade name “Monel” by Special Metals Corporation, and are connected to the power supply lines 7 of the integral lamp 4 via welded joints 13. As a result, both the mechanical holding of the integral lamp 4 and the electrical contact-making by means of the power supply wires 9a, 9b is made possible.

The first power supply wire 9a is passed on upwards, past the base 8 of the integral lamp 4, and is coiled in the form of a spiral around the bulb 14 of the integral lamp 4, while the second power supply wire 9b ends at the power supply line 7 of the integral lamp 4.

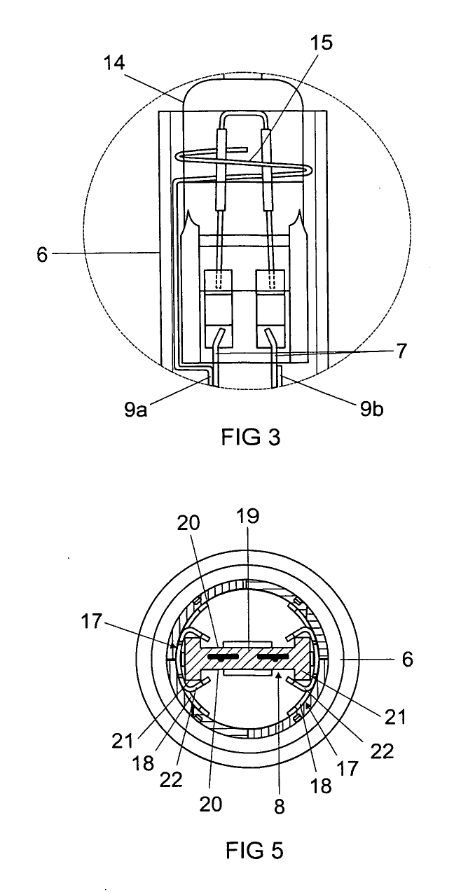

As can be seen from FIG. 3, the wire section 15, which is coiled in the form of a spiral, of the first power supply wire 9a in the normal state touches neither the cylindrical bulb 6 nor the bulb 14 of the integral lamp 4. If, however, the integral lamp 4 begins to vibrate, for example as a result of impact loading, the direct contact between the bulb 14 of the integral lamp 4 and the cylindrical bulb 6 is reliably prevented and the impact as a result of the elastic properties of the wire section 15 is additionally damped.

The lamp 1 shown in the first exemplary embodiment is manufactured by virtue of the fact that, first, the power supply wires 9a, 9b reaching from the base 2 to the integral lamp 4 are welded to the power supply lines 7 of the integral lamp 4 and then the first power supply wire 9a is coiled in the form of a spiral around the bulb 14 of the integral lamp 4. Then, the integral lamp 4 is inserted into the preferably cylindrical bulb 6, the outer bulb 3 is fused to the preferably cylindrical bulb 6 and the first power supply wire 9a is bent back laterally in the form of a U, with the result that contact can be produced with the base 2. Then, the base 2 is fitted onto the outer bulb 3 and cement which has previously been applied to the base 2 is baked, so that the base 2 is connected to the outer bulb 3. Finally, the power supply wires 9a, 9b are cut to length and connected to the base 2 in a known manner by means of soldering. In principle, however, it is also conceivable for the wire section 15 of the first power supply wire 9a to be prebent in coiled fashion so that the integral lamp 4 can be inserted into this coil in order then for the power supply lines 7 of the integral lamp 4 to be connected to the power supply wires 9a, 9b.

In the present exemplary embodiment, the cylindrical bulb 6 is formed from the same glass as the outer bulb 3. This ensures that it is easily possible for the two bulbs 3, 6 to be connected to one another and allows for cost-effective production since there are no stringent requirements placed on the two glasses and therefore a conventional glass, in particular a so-called soft glass, can be used. However, depending on the embodiment of the integral lamp 4, other materials are also conceivable for the bulbs, for example other glasses or other ceramic or polymeric materials. It is likewise conceivable for the cylindrical bulb 6 to be partially or completely provided with a single-layer or multilayer coating, which shields, reflects or transmits wavelength ranges selectively, for example. A matt finish is likewise conceivable.

Whether the power supply wire 9a which is connected to the center contact 12 or the power supply wire 9b which is connected to the side contact 11 of the base 2 is passed out of the base 8 of the integral lamp 4 and coiled around it is insignificant for the implementation of the invention; embodiments are even conceivable in which both power supply wires 9a, 9b are designed in this way.

Instead of the spiral coil formation, a formation in the form of a ring or a combination of the two variants is also conceivable. If, instead of a cylindrical bulb 6, a different cross-sectional shape, for example an oval or a polygon, is selected, the shape of the turns of the wire 15 should naturally be selected appropriately, with the result that oval or polygonal turns are also conceivable, for example.

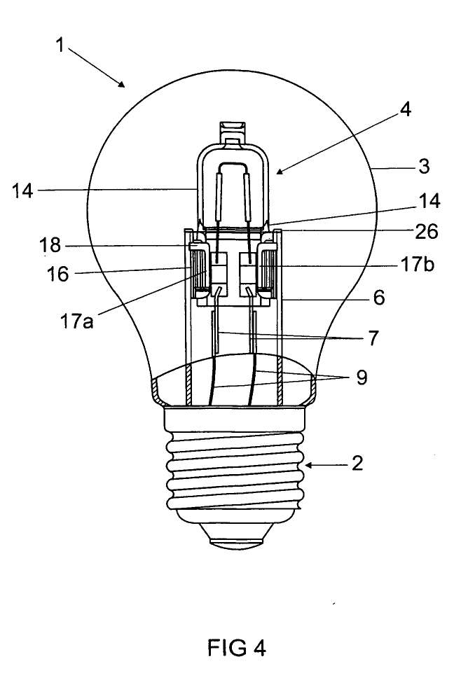

FIG. 4 shows a lamp 1 according to the invention in accordance with a second embodiment in a side view. The basic design with the base 2, the outer bulb 3, the cylindrical bulb 6 which is fused to the outer bulb 3, and the integral lamp 4 corresponds to the lamp 1 shown in FIG. 1. In contrast to the first exemplary embodiment, however, in this case the cylindrical bulb 6 is only guided as far as the lower edge of the bulb 14 of the integral lamp 4. A holding apparatus 16, in which the integral lamp 4 is held, is arranged in the cylindrical bulb 6.

The holding apparatus 16 substantially comprises two holding elements 17, which surround the base 8 of the integral lamp 4 and comprise two holding elements 18 in the form of circular arcs which fix the holding apparatus 16 in the cylindrical bulb 6.

As can be seen from FIG. 5, which shows a horizontal section through the base 8 of the integral lamp 4, the base 8 of the integral lamp 4 typically has a double T cross section, in which a rib 19 with two planar-parallel faces 20 is arranged between lateral flanges 21. The holding elements 17 substantially comprise in each case two lateral holding clips 22, which engage in a sprung manner around the lateral flanges 21 of the base 8 of the integral lamp 4 and, as a result, ensure precise guidance of the base 8, and the holding elements 18 in the form of circular arcs.

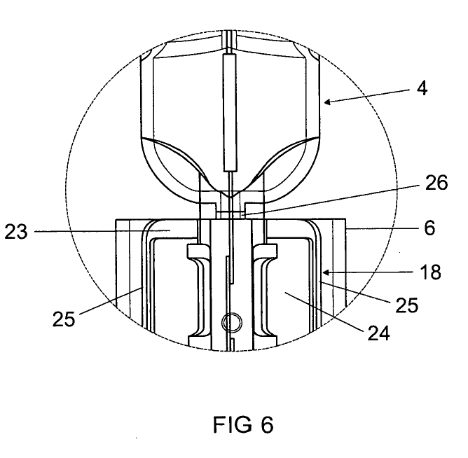

FIG. 6 shows, in a sectional illustration in which the section plane is covered by the longitudinal axis of the lamp 1 and the vertical to the web 19 of the base 8 of the integral lamp 4, that the holding elements 18 in the form of circular arcs are formed substantially by in each case two arc lugs 23, which each have a cutout 24 in the interior, as a result of which, firstly, material is saved and, secondly, the spring action of the arc lugs 23 can be selected to be sufficiently small for overloading of the cylindrical bulb 6 to be reliably avoided.

The arc lugs 23 bear primarily by means of holding ribs 25 against the cylindrical bulb 6, which, as a result of the reduced bearing surface area in comparison with a holding lug bearing over the entire area, facilitates insertion of the holding apparatus 16 into the cylindrical bulb 6. Holding tabs 26 prevent the holding apparatus 16 from being inserted too far into the cylindrical bulb 6. In addition to the force-fitting fixing of the integral lamp 4 by means of the holding apparatus 16, the power supply wires 9, which reach from the base 2 to the integral lamp 4 and which are welded to the power supply lines 7 of the integral lamp 4 and are connected to the base 2 of the lamp 1 as in the first exemplary embodiment, prevent the holding apparatus 16 and the integral lamp 4 from sliding out.

Nevertheless, in this embodiment, the power supply wires 9 do not need to absorb any, or only very low, holding forces for the integral lamp 4 and can therefore be designed to be very simple and thin.

When the lamp 1 is fitted, first the integral lamp 4 is inserted into the two holding elements 18 of the holding apparatus 16, and then the power supply wires 9 are welded to the power supply lines 7 of the integral lamp 4, it also being possible for this sequence to be carried out in reverse order. Then, the power supply wires 9 and the holding apparatus 16 are inserted into the cylindrical bulb 6 and the outer bulb 3 is turned back over it and fused to the cylindrical bulb 6. Further fitting takes place in a similar manner to in the first exemplary embodiment.

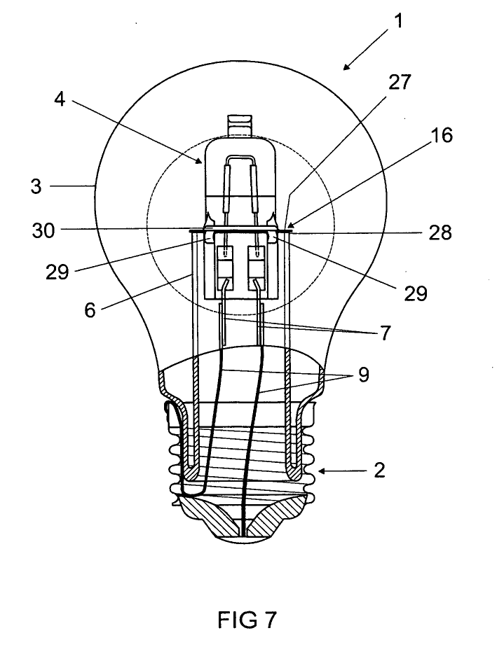

A further embodiment of a lamp 1 according to the invention is shown in FIG. 7 in a side view. The basic design of the lamp 1 with a base 2, an outer bulb 3, a cylindrical bulb 6, which is fused to the outer bulb 3, and an integral lamp 4 in turn corresponds to the lamps 1 shown in the previous exemplary embodiments. In this exemplary embodiment, the holding apparatus 16 substantially comprises a disk 27, which rests on the upper edge 28 of the cylindrical bulb 6 and is fixed there by means of four spring lugs 29. The spring lugs 29 press from the inside against the wall of the cylindrical bulb 6, as a result of which a compact design, a simple configuration and easy fitting are made possible. However, embodiments are also conceivable in which the spring lugs 29 act from the outside on the bulb 6, as a result of which in particular the loading of the bulb 6 by tangential tensile forces is markedly reduced.

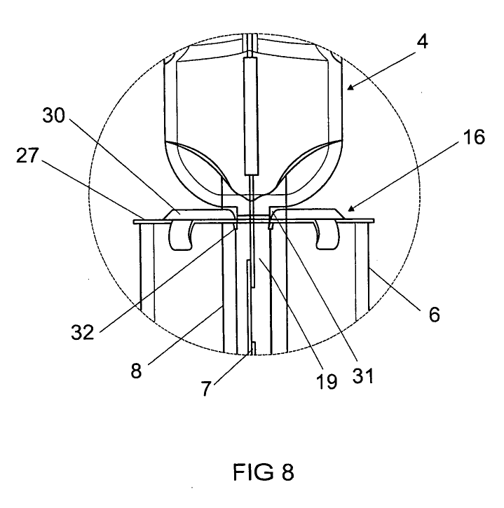

FIG. 8 shows the holding apparatus 16 in a detail view which has been rotated through 90° about the lamp longitudinal axis in comparison with FIG. 7. The disk 27 has, in its center, an elevated region 30, in which a cutout 31 is introduced. The stepped configuration of the disk 27 results in optimized rigidity of the disk 27. The base 8 of the integral lamp 4 is held in the cutout 31. Optimum guidance and fixing of the integral lamp 4 is in this case ensured by virtue of the cutout 31 approximately corresponding to the cross-sectional area of the base 8 of the integral lamp 4, i.e. in the present case being approximately in the form of a double T.

In the region of the web 19 of the double T profile, the disk 16 has spring lugs 32, which fix the integral lamp 4 securely in the axial direction and therefore, together with the disk 27, act as the holding clip.

The power supply lines 7 of the integral lamp 4 are welded to the power supply wires 9 as shown in the preceding exemplary embodiments and are connected to the base 2. In this arrangement as well, the power supply wires 9 are largely relieved of holding forces and only act as an additional securing measure against the integral lamp 4 falling out if the latter points downwards.

Fitting takes place in a similar manner to the preceding exemplary embodiment by virtue of the fact that, first, the integral lamp 4 is inserted into the cutout 31 of the disk 27 and then the power supply wires 9 are welded to the power supply lines 7 of the integral lamp, it also being possible for this sequence to be carried out in reverse order. In the case of the first variant, however, the integral lamp 4 can be fixed in a particularly simple manner by means of the holding apparatus 16. Then, the power supply wires 9 and the holding apparatus 16 are inserted into the cylindrical bulb 6, and the outer bulb 3 is turned back over it and fused to the cylindrical bulb 6. Further fitting takes place in a similar manner to the first exemplary embodiment.

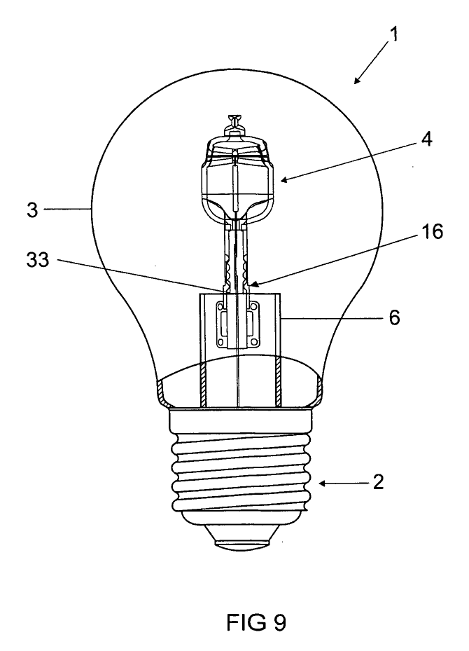

FIG. 9 shows a lamp 1 according to the invention in accordance with a fourth embodiment in a lateral illustration. The basic design with a base 2, an outer bulb 3, a cylindrical bulb 6 fused to the outer bulb 3 and an integral lamp 4 corresponds to the lamp 1 shown in FIG. 1. In contrast to the first exemplary embodiment, however, in this case the cylindrical bulb 6 is only guided as far as the lower edge 33 of the integral lamp 4. A holding apparatus 16 is arranged in the cylindrical bulb 6.

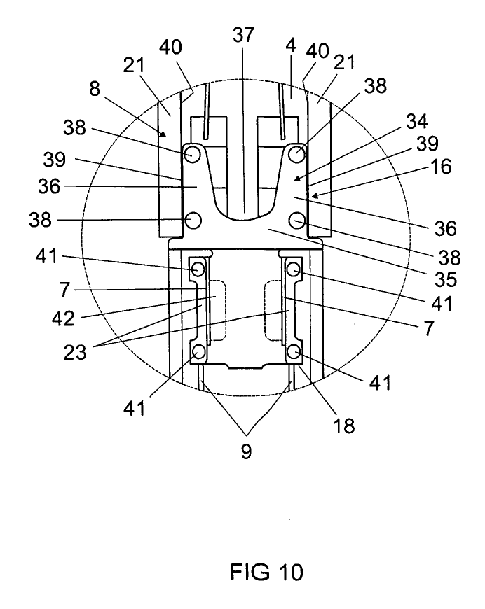

As can be seen from FIG. 10, which shows the holding apparatus 16 as a detail illustration and rotated through 90° with respect to FIG. 9, the holding apparatus 16 substantially comprises a holding clip 34, which holds the base 8 of the integral lamp 4, and two holding elements 18 in the form of circular arcs which fix the holding apparatus 16 in the cylindrical bulb 6. The radius of the holding elements 18 in the form of circular arcs, of which only the front one is illustrated here, in this case corresponds practically to the inner radius of the cylindrical bulb 6, as a result of which the holding elements 18 bear tight against the bulb 6 and a good spring action is achieved.

The holding clip 34 substantially comprises two holding lugs 35, which are arranged in planar-parallel fashion and of which only the front one is visible in FIG. 10. The holding lugs 35 in turn are each formed from two holding tongues 36, between which a U-shaped cutout 37 is located. The holding lugs 35 bear in a sprung manner against the base 8 of the integral lamp 4 and have in each case four holding knobs 38, which, as a result of their rounded-out formation, facilitate the insertion of the integral lamp 4 into the holding clip 34 and ensure a secure hold. For improved lateral guidance of the base 8, the holding tongues 36 are spaced apart in such a way that the outer edges 39 of the holding tongues 36 bear against the inner edges 40 of the flanges 21 of the double T profile.

The holding elements 18 are arranged in such a way that they are spaced apart axially from the holding clip 34. The two holding elements 18 in the form of circular arcs are substantially formed by in each case two arc lugs 23. These arc lugs 23 bear, primarily by means of holding knobs 41, against the cylindrical bulb 6, which facilitates the insertion of the holding apparatus 16 into the bulb 6 and ensures a secure hold of the holding apparatus 16 in the cylindrical bulb 6. The configuration of the holding apparatus 16 with an opening 42 between the holding elements 18 makes it possible to weld the power supply wires 9 to the power supply lines 7 of the integral lamp 4, even if the integral lamp 4 has already been inserted into the holding clip 34.

As a result of the fact that the holding clip 34 and the holding elements 18 are spaced apart axially from one another, the holding apparatus 16 can be designed to have a particularly small cross section, and the cylindrical bulb 6 can be configured so as to be shorter and to have a smaller diameter than in the preceding exemplary embodiments. A diameter of the cylindrical bulb 6 which is as small as possible is particularly advantageous because the latter can then also be inserted into lamps with a small base 2, and therefore a universal use of a cylindrical bulb 6 for different lamps 1 with respectively different base sizes is made possible.

In this embodiment as well, the power supply wires 9 do not need to absorb any holding forces, or only very low holding forces, for the integral lamp 4 and can therefore have a very simple and thin configuration.

During fitting of the lamp 1, in a similar way to the preceding exemplary embodiments, first the integral lamp 4 is inserted into the holding clip 34 of the holding apparatus 16 and then the power supply wires 9 are welded to the power supply lines 7 of the integral lamp 4, it also being possible for this sequence to be carried out in reverse order. Then, the power supply wires 9 and the holding apparatus 16 are inserted into the cylindrical bulb 6, and the outer bulb 3 is turned back over it and fused to the cylindrical bulb 6. Further fitting takes place in a similar way to the first exemplary embodiment.

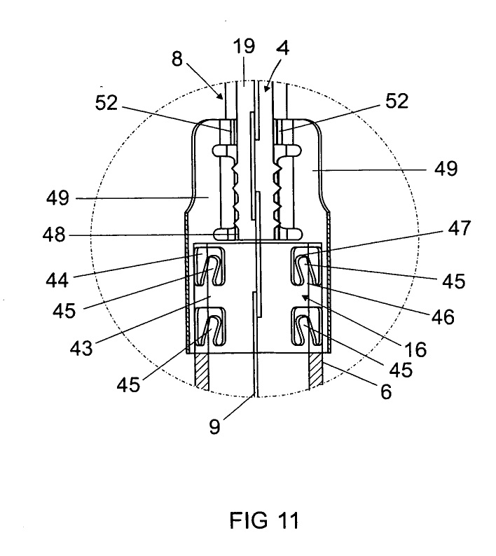

A similar embodiment is shown as a fifth exemplary embodiment in a detail view in FIG. 11, in this case only the cylindrical bulb 6 with the holding apparatus 16 and the integral lamp 4 being illustrated in a sectional illustration, in which the sectional plane is covered by the longitudinal axis of the lamp 1 and the perpendicular to the web 19 of the base 8 of the integral lamp 4.

In this exemplary embodiment, the holding apparatus 16 is formed substantially from a cylindrical part 43, which comprises the bulb 6 and whose inner diameter approximately corresponds to the outer diameter of the bulb 6. On the cylindrical part 43, spring lugs 45 are arranged in cutouts 44, which spring lugs 45 compensate for the dimensional difference between the inner diameter of the cylindrical part 43 and the outer diameter of the bulb 6 and thus ensure a firm hold of the holding apparatus 16 on the cylindrical bulb 6. The formation of the spring lugs 45, which are connected at the lower edge 46 to the cylindrical part 43 and protrude inwards with the upper edge 47, ensures both simple insertion of the bulb 6 into the cylindrical part 43 and effective fixing in the opposite direction. As a result, the power supply wires 9 in this embodiment as well only need to absorb very low holding forces for the integral lamp 4 and can therefore be configured so as to be very simple and thin.

In the upper region, the holding apparatus 16 has two rectangular cutouts 48, by means of which the cylindrical basic body is split into two cylinder segments 49. The integral lamp 4 is held in these cutouts 48 by means of spring lugs 52.

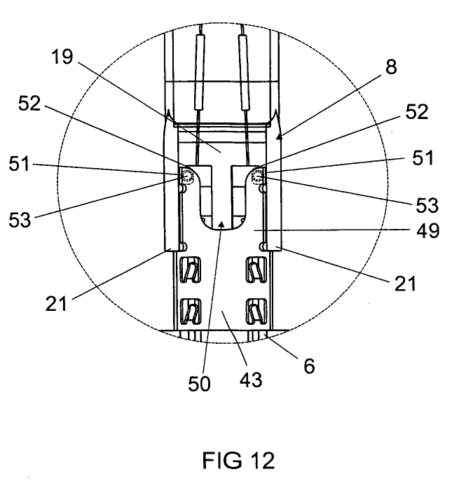

As can be seen from FIG. 12, which illustrates a side view of the fifth exemplary embodiment with a viewing direction rotated through 90° with respect to FIG. 11, the cylindrical segments 49 in turn each have a U-shaped cutout 50, as a result of which the base 8 of the integral lamp 4 remains largely visible and savings are made on material. The spring lugs 52, which are provided at the edges 51 of the rectangular cutouts 48, have holding knobs 53 with the advantages already described.

The diameter of the cylindrical part 43 and therefore also of the cylindrical bulb 6 is in this case selected, taking into consideration the thickness of the web 19, in such a way that in each case the outer edges 51 of the cylinder segments 49 bear against the inner side of the flange 21. As a result, guidance in the radial direction parallel to the web 19 of the base 8, which is in the form of a double T, can be realized in a simple manner and the integral lamp 4 is fixed on all sides.

During fitting of the lamp 1, first the power supply wires 9 are welded to the power supply lines 7 of the integral lamp 4, then the integral lamp 4 is inserted into the cylinder segments 49 of the holding apparatus 16, and then the power supply wires 9 and the holding apparatus 16 are pushed onto the cylindrical bulb 6. Finally, the outer bulb 3 is turned back over it and fused to the cylindrical bulb 6. Further fitting takes place in a similar way to the first exemplary embodiment.

Instead of the outer bulb 3, which is shown in the exemplary embodiments and is typical of a general-service incandescent lamp, with the designation A55, other bulb shapes, such as types A60, R63, R80 or G95, for example, are naturally also conceivable, and other base sizes, such as E14 or E40, for example, and other types of base such as a bayonet-type base or plug-type base, for example, are also possible instead of the screw-type base shown of the type E27. Of course the power supply wires 9 do not necessarily need to have a circular cross section but can instead have any desired shape, in particular rectangular or triangular shapes and hollow cross sections.

1. An electric lamp (1) with a base at one end and with an outer bulb (3), mounted in a base (2), and at least one integral lamp (4), preferably a high-volt halogen lamp, which is arranged within the outer bulb (3), and at least two power supply wires (9, 9a, 9b) from the base (2) to the integral lamp (4), characterized in that the at least two power supply wires (9, 9a, 9b) are surrounded by a preferably cylindrical bulb (6) made from nonconductive material, and the cylindrical bulb (6) is connected, preferably fused, to the outer bulb (3).

2. The electric lamp (1) with a base at one end as claimed in claim 1, characterized in that the cylindrical bulb (6) is formed from a light-permeable material, preferably identical to the material used for the outer bulb (3), in particular glass.

3. The electric lamp (1) with a base at one end as claimed in claim 1, characterized in that the integral lamp (4) is at least partially surrounded by the preferably cylindrical bulb (6).

4. The electric lamp (1) with a base at one end as claimed in claim 1, characterized in that at least one holding apparatus (16) for fixing the integral lamp (4) is provided on the preferably cylindrical bulb (6).

5. The electric lamp (1) with a base at one end as claimed in claim 1, characterized in that the holding apparatus (16) has at least one spring element (22, 23, 29, 32, 35, 45, 52).

6. The electric lamp (1) with a base at one end as claimed in claim 1, characterized in that the holding apparatus (16) has at least one holding clip (22, 34, 49) for the integral lamp (4), comprising at least two holding lugs (22, 35, 52), which are preferably arranged approximately planar-parallel.

7. The electric lamp (1) with a base at one end as claimed in claim 6, characterized in that at least one of the holding lugs (35, 52) comprises at least one spring element (35, 52), in particular is in the form of a spring element (35, 52).

8. The electric lamp (1) with a base at one end as claimed in claim 1, characterized in that the holding apparatus (16) can be connected in a force-fitting manner to the preferably cylindrical bulb (6) by means of at least one spring element (23, 29, 45).

9. The electric lamp (1) with a base at one end as claimed in claim 8, characterized in that the spring element (23, 29, 45) is operatively connected to at least one holding element (18, 43), which is approximately in the form of a circular arc, the diameter of the circular arc approximately corresponding to the inner diameter or the outer diameter of the preferably cylindrical bulb (6).

10. The electric lamp (1) with a base at one end as claimed in claim 8, characterized in that the holding element (18, 43), which is approximately in the form of a circular arc, and the holding lugs (35, 52) of the holding clip (34) are arranged axially spaced apart from one another.

11. The electric lamp (1) with a base at one end as claimed in claim 8, characterized in that the direction of force of the spring element (23) of the holding element (18), which is approximately in the form of a circular arc, and of the holding lugs (22) of the holding clip are arranged approximately orthogonally with respect to one another.

12. The electric lamp (1) with a base at one end as claimed in claim 8, characterized in that the direction of force of the spring element (29) of the holding element (18), which is approximately in the form of a circular arc, and of the holding lugs (35) are arranged approximately parallel to one another.

13. The electric lamp (1) with a base at one end as claimed in claim 1, characterized in that the holding apparatus (16) has a substantially disk-shaped element (27) with a cutout (31) for accommodating the integral lamp (4), the disk-shaped element (27) approximately having the cross-sectional area of the preferably cylindrical bulb (6).

14. The electric lamp (1) with a base at one end as claimed in claim 13, characterized in that the cutout (31) for accommodating the integral lamp (4) has approximately the contour of the cross-sectional area of the base (8) of the integral lamp (4).

15. The electric lamp (1) with a base at one end as claimed in claim 13, characterized in that the disk-shaped element (27) is in the form of a stamped part made from a metallic material.

16. The electric lamp (1) with a base at one end as claimed in claim 13, characterized in that spring lugs (29, 32) for fixing the disk-shaped element (27) are provided in the preferably cylindrical bulb (6) and/or the integral lamp (4) in the disk-shaped element (27).

17. The electric lamp (1) with a base at one end as claimed in claim 1, characterized in that the power supply wires (9a, 9b) are configured as a holding apparatus for the integral lamp (4).

18. The electric lamp with a base at one end as claimed in claim 1, characterized in that at least one wire section (15), which is coiled around the bulb (14) of the integral lamp (4) preferably in the form of a sprial and/or in the form of a ring, is arranged between the bulb (14) of the integral lamp (4) and the preferably cylindrical bulb (6).

19. The electric lamp (1) with a base at one end as claimed in claim 18, characterized in that the coiled wire section (15) is connected, in particular welded, to a power supply wire (9a, 9b), which leads from the base (2) to the integral lamp (4).

20. The electric lamp (1) with a base at one end as claimed in claim 18, characterized in that the coiled wire section (15) and at least one power supply wire (9a), which leads from the base (2) to the integral lamp (4), are designed to be integral.

21. The electric lamp (1) with a base at one end as claimed in claim 1, characterized in that at least one power supply wire (9a, 9b), which leads from the base (2) to the integral lamp (4), is connected to at least one power supply line (7) of the integral lamp (4) by a welded joint (13).

22. The electric lamp (1) with a base at one end as claimed in claim 1, characterized in that at least one power supply wire (9a), which leads from the base (2) to the integral lamp (4), is led, in the region of the base (2), in the form of a U around the preferably cylindrical bulb (6).

23. The electric lamp (1) with a base at one end as claimed in claim 1, characterized in that the power supply wires (9a, 9b), which lead from the base (2) to the integral lamp (4), are formed from a nickel/copper alloy.

24. A method for producing an electric lamp (1) with a base at one end and with an outer bulb (3), mounted in a base (2), and at least one integral lamp (4), preferably a high-volt halogen lamp, which is arranged within the outer bulb (3), and at least two power supply wires (9, 9a, 9b), which lead from the base (2) to the integral lamp (4), characterized by the following steps:
a) the integral lamp (4) is connected, preferably welded, to the power supply wires (9, 9a, 9b),
b) the power supply wires (9, 9a, 9b) are inserted into a preferably cylindrical bulb (6) made from a nonconductive material, with the result that the at least two power supply wires (9a, 9b) are largely surrounded by the preferably cylindrical bulb (6),
c) the outer bulb (3) is connected, preferably fused, to the preferably cylindrical bulb (6),
d) a power supply line (9a) is bent back laterally in such a way that contact with the base (2) can be produced,
e) the base (2) is fitted onto the outer bulb (3) and is preferably connected using cement applied to the base (2),
f) the power supply wires (9, 9a, 9b) are cut to length and are connected to the base (2) preferably by means of soldering.

25. The method as claimed in claim 24, characterized in that, between steps a) and b), at least one power supply wire (9a) is coiled preferably in the form of a spiral and/or in the form of a ring around the bulb (14) of the integral lamp (4).

26. The method as claimed in claim 24, characterized in that at least one power supply wire (9a) is coiled preferably in the form of a ring and/or spiral prior to being connected to the integral lamp (4).

27. The method as claimed in claim 24, characterized in that, before or after step a), the integral lamp is introduced into a holding apparatus.
